(19) United States
(12) Patent Application Publication
(10) Pub. No.: US 2023/0042518 A1
(43) Pub. Date: Feb. 9, 2023

(54) Portable Cannabidiol Testing Device

(71) Applicants: Drew Phillip LaMarca, Island Heights, NJ (US); Thomas Phillip LaMarca, Island Heights, NJ (US); Rebecca Ann LaMarca, Island Heights, NJ (US)

(72) Inventors: Drew Phillip LaMarca, Island Heights, NJ (US); Thomas Phillip LaMarca, Island Heights, NJ (US); Rebecca Ann LaMarca, Island Heights, NJ (US)

(21) Appl. No.: 17/444,467

(22) Filed: Aug. 4, 2021

(51) Int. Cl. G01N 21/31

(52) U.S. Cl. CPC G01N 21/3103; G01N 2201/0221; G01N 2021/3125

(57) ABSTRACT

A Portable cannabidiol testing system which operates by selectively using specific visible wavelengths of light which are absorbed by the cannabidiol (CBD) chemical compound. The visible light spectrum source is tuned to wavelengths of light absorbed by the cannabidiol chemical compound. The testing system allows for verification of CBD content within a sample. The system utilizes a single use container with a premeasured reagent which allows for a reduction in the number of steps required for the testing process. An intrinsically safe light source and sensor are tuned to at least one specific wavelength of CBD light absorption and submerged in the CBD/Acetone reagent solution.

### BACKGROUND

In recent years there has been a significant increase in the amount of CBD or Hemp Oil based products on the market. These products contain meaningfully different amounts of the chemical CBD, based on each individual manufacturer, often varying with each product batch. There are numerous distributors of CBD products and little regulatory structure to guarantee the exact content of any given product. In order to obtain any real benefit of CBD products, its potential users need to be able to obtain an accurate verification of the CBD content of any given batch of CBD product.

Various tools and systems exist to test the content of Cannabidiol (CBD) contained within a sample. These tools are generally priced for the higher end of the market and can required significant training in order to operate properly. The tools available range from inaccurate lower cost testing systems to laboratory grade systems that require careful testing procedures in order to ensure accuracy. Several of the available testing systems are physically large and not easily portable. In order for the CBD or Hemp Oil testing process to be performed it is often necessary to measure accurate amounts of a reagent to obtain accurate results, something which is generally difficult to do without a proper testing environment.

One method of determining chemical composition involves spectrophotometry which measures the amount of light which passes through a sample. Spectrophotometry requires properly tuned equipment, a cuvette, and measurements in order to determine the content of a sample. The testing process can be error prone if not followed correctly.

For the foregoing reasons, there is a need for a system which is both less cumbersome and easier to use.

### SUMMARY

The present invention is directed to portable CBD or Hemp Oil testing system which satisfies this need. The portable CBD or Hemp Oil testing system comprises a prefilled reagent container and electronic testing apparatus. The electronic testing apparatus includes a light emitter, a light detector, a battery, a test module for the CBD Reagent Solution, and a display device.

### DESCRIPTION

A preferred embodiment of the endocannabidiol detection device provides a prefilled reagent container which is constructed a transparent or semitransparent material. The reagent container is filled with a premeasured reagent. The reagent container includes a filter and a removable top. The electronic testing apparatus, which includes a of light detector, a light emitter, a battery, a CBD Test Module for the CBD reagent solution, and a display device. The material to be tested can be added to the reagent container by removing the top, adding an amount of the substance to be tested, which is mixed and then passes through the filter, and then the user replaces the reagent container top prior to testing. Once the material to be tested is added to the reagent container the CBD Reagent solution is placed inside of the CBD Test module of the electronic testing apparatus.

The electronic testing apparatus is then turned on and the light emitter shines light through the CBD Reagent solution and onto the light detector. The light detector measures the light which is transmitted through the CBD Reagent solution and provides a reading on the display device which indicates the amount of light that passes through the CBD Reagent solution. The specific wavelengths of light emitted are in the visible light spectrum of 380 nm to 740 nm.

In the Summary above and in the sections below, and in the accompanying drawings, reference is made to particular features of the invention. It is so understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components.

Where reference is made herein to a method comprising two or more defined steps, the defined steps can be carried out in any order or simultaneously (except where the context excludes that possibility), and the method can include one or more other steps which are carried out before any of the defined steps (except where the context excludes that possibility).

The term “at least” followed by a number is used herein to denote the start of a range beginning with that number (which may be a range having an upper limit or no upper limit, depending on the variable being defined}. For example “at least 1” means 1 or more than 1. The term “at most” followed by a number is used herein to denote the end of a range ending with that number (which may be a range having 1 or 0 as its lower limit, or a range having no lower limit, depending upon the variable then being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 nm means a range whose lower limit is 25 nm, and whose upper limit is 100 nm.

The invention does not require that all of the advantageous features and all the advantages need to be incorporated into every embodiment of the invention.

### DESCRIPTION OF THE DRAWINGS

FIG. 1 illustrates a front perspective view of an embodiment of the endocannabidiol detection device, namely, the CBD Test Module and Mixing Chamber Module for detecting the cannabidiol chemical attributes for presence and relative amount. The CBD Test Module can be used with and without the Chamber Mixing Module.

FIG. 2 illustrates a top view of an embodiment of the endocannabidiol detection device, namely, of the CBD Test Module and Mixing Chamber Module showing the part description.

FIG. 3 illustrates a right side view of an embodiment of the endocannabidiol detection device, namely, of the CBD Test Module and Mixing Chamber Module showing the part description.

FIG. 4 illustrates a front perspective exploded view of an embodiment of the endocannabidiol detection device, namely, of the CBD Test Module and Mixing Chamber Module showing the part description.

FIG. 5 illustrates a right side sectional view of an embodiment of the endocannabidiol detection device, namely, of the CBD Test Module connected to the Power Module showing an Intrinsically Safe (IS) description.

FIG. 6 illustrates a right side sectional view of an embodiment of the endocannabidiol detection device, namely, of the CBD Test Module showing the part description.

FIG. 7 illustrates a flow chart and right side sectional view of an embodiment of the endocannabidiol detection device, namely, of the CBD Test Module showing the submerged Light Source and Light Sensor in the CBD Reagent Solution which is Acetone and CBD chemical compound.

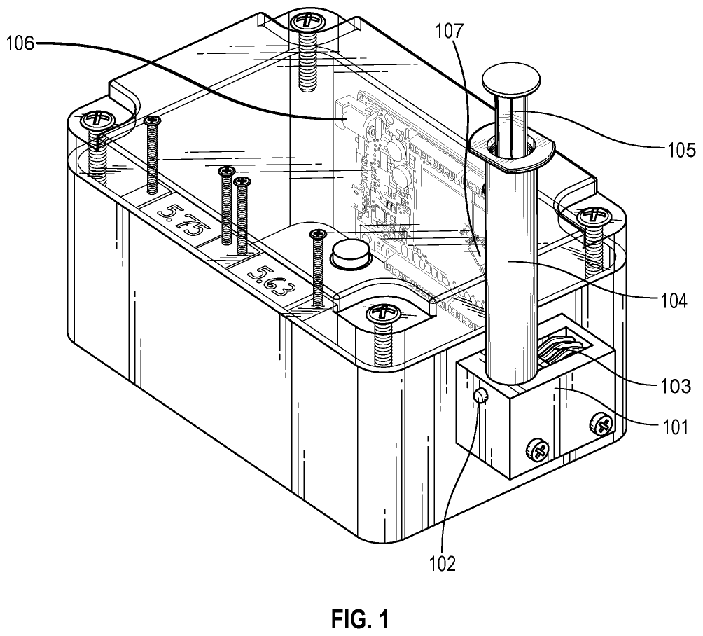

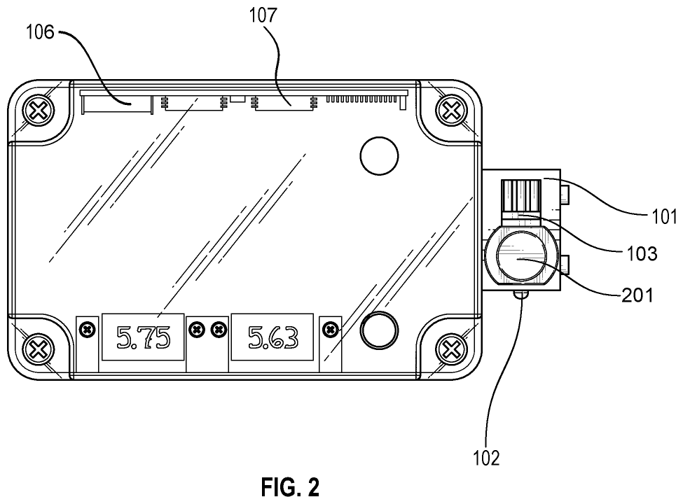

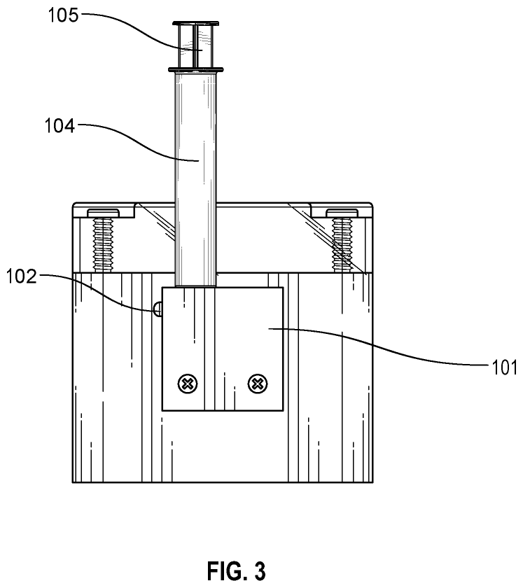

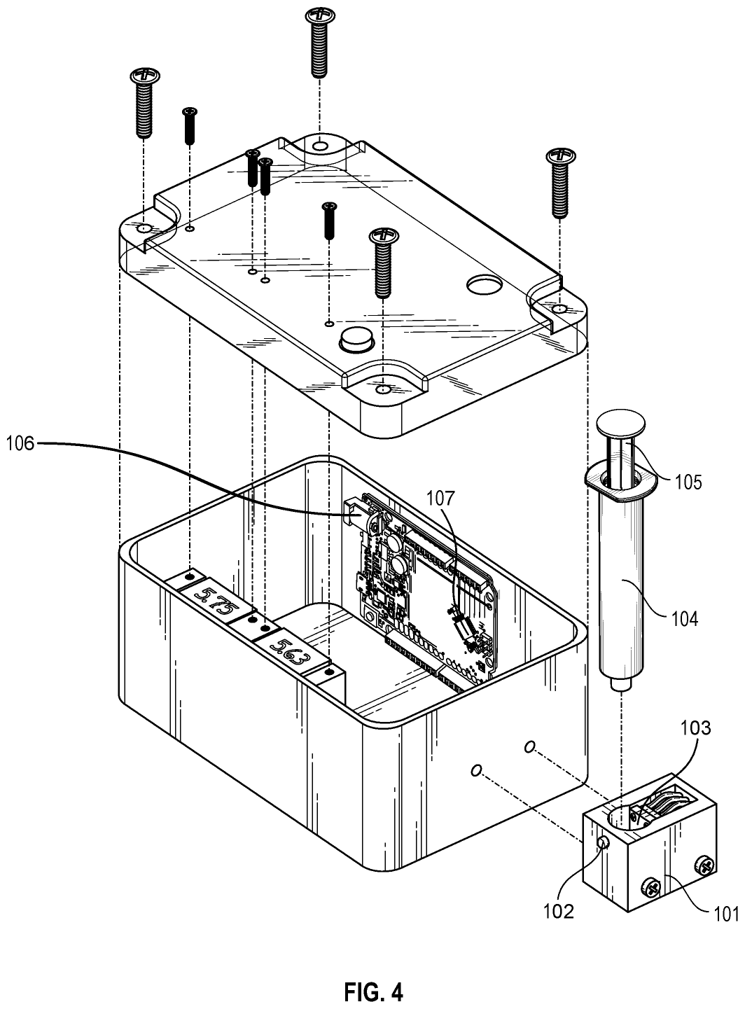

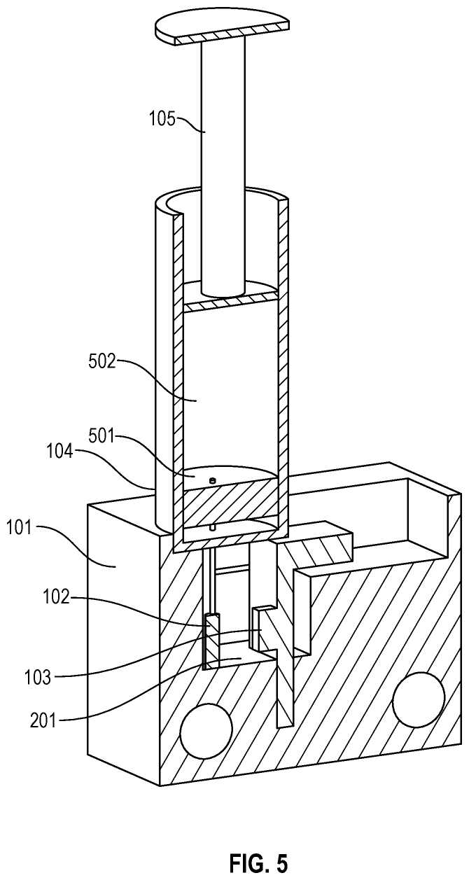

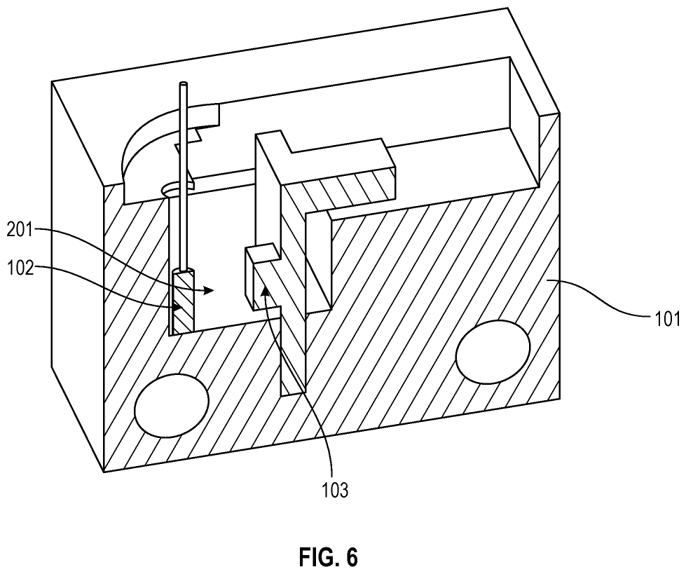

As shown in FIG. 1, FIG. 2, FIG. 3, FIG. 4, FIG. 5, and FIG. 6 of an embodiment of the endocannabidiol detection device the Test Module 101 contains a Light Source, the Surface Mount LED 102, a Light Sensor 103, a CBD Reagent Solution 201. The Mixing Chamber Module 104, which has a Micron Filter 501, an Acetone Solution 502, and a Removeable Plunger 105.

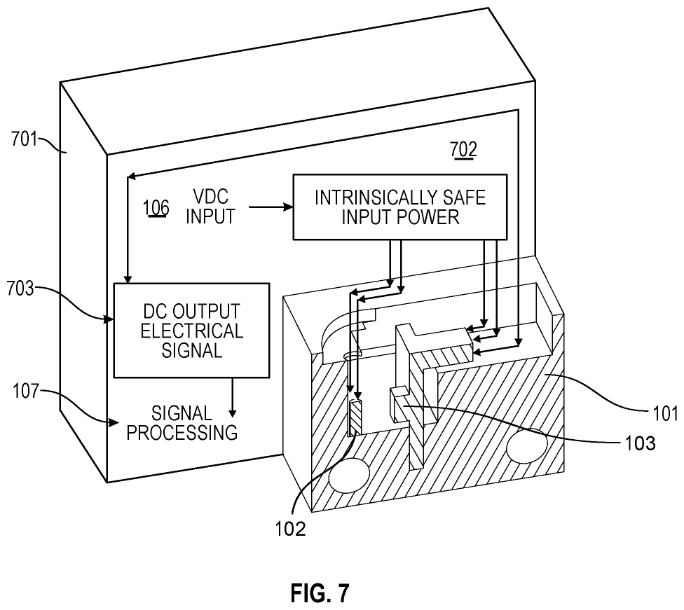

As shown in FIG. 7, an embodiment of the endocannabidiol detection device. The Power Module 701 contains an Intrinsically Safe Power 702, which is powered by Input Power 106, a Processor 107 send an Output Signal 703.

In the sampling for the presence of Cannabidiol (CBD), the retail CBD or Hemp Oil Product is diluted in acetone to mitigate the effects of other ingredients in the retail CBD and Hemp Oil products. Referring to FIG. 5, the Mixing Chamber Module 104 allows the retail CBD or Hemp Oil product in low volume to be diluted and mixed with acetone, for example, acetone in high volume, thoroughly. The diluted retail CBD or Hemp Oil product solution, the Acetone Solution 502, is moved through a Micron Filter 501 by Removeable Plunger 105. The test solution, CBD Reagent Solution 201, is ready for testing and placed in the reagent Test Module 101 for detection and relative amount.

Referring to FIG. 7, the test solution, CBD Reagent Solution 201, is placed in the Test Module 101. A Intrinsically Safe Power 702 is turned on from the incoming line voltage, Input Power 106. The specific wavelength of light source, Surface Mount LED 102, and light spectrum sensor, Light Sensor 103, are energized. The test solution, CBD Reagent Solution 201, absorbs the specific band of light. The CBD chemical compound concentration absorbs multiple specific wavelengths of light. The remaining non absorbed light is recorded by a respective output electrical signal, Output Signal 703, from the light spectrum sensor, Light Sensor 103. The sensor output is an AC or DC output electrical signal, Output Signal 703, that can be processed by a microcontroller or validated by an output circuit or meter, Processor 107. The microcontroller, output circuit or meter, Processor 107, provides quantitative results for validation of the cannabidiol chemical compound presence and its relative amount.

Referring to FIG. 5, the light source, Surface Mount LED 102, and light spectrum sensor, Light Sensor 103, are gap sized dimensionally in the Test Module 101 to give the ideal absorption resolution for the test solution, CBD Reagent Solution 201. The light source, Surface Mount LED 102, and light spectrum sensor, Light Sensor 103, are submerged in the test solution, CBD Reagent Solution 201.

The test solution, CBD Reagent Solution 201, clarity or transparency and the output AC or DC output electrical signal, Output Signal 703, resolution are calibrated against a reagent container filled with 100% acetone that produces the highest AC or DC output electrical signal, Output Signal 703, for calibration.

Although embodiments of the present invention have been described in considerable detail with reference to certain preferred versions thereof, other versions are possible. For example, the reagent container shown is round, but could be replaced with any other type of reagent container which serves the desired purpose. Therefore, the spirit and scope of this application should not be limited to the description of the preferred versions contained herein.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features which service the same, equivalent or similar purpose, unless expressly stated otherwise. Thus, unless expressly stated otherwise, each feature disclosed is one example only of a generic series of equivalent or similar features.

What is claimed is:

1. A Portable CBD endocannabidiol detection device is for testing and analyzing the cannabidiol chemical attributes for presence and relative amount in available retail CBD or Hemp Oil that is diluted in an organic compound, comprising:
a power module, a CBD test module, and a mixing chamber module;
a light source for delivering a specific visible wavelength of light or band of light is mounted in said CBD Test Module, said CBD Test Module contains a CBD reagent solution, said light source is submerged in said CBD reagent solution to reduce light refraction; the specific wavelength of light is absorbed by the CBD chemical compound concentration in the CBD reagent solution sample;
a plurality of a light sensors positioned in said CBD Test Module and submerged in the CBD reagent solution to capture the remaining non-absorbed and non-refracted light from the CBD reagent solution sample; the non-absorbed and non-refracted light is in relation to a specific output electrical signal; a value of the output electrical signal is relative to the amount of light absorption of the CBD reagent solution; the amount of light absorption is based on concentration of the CBD chemical attributes in retail CBD and Hemp Oil products;
the CBD Test Module that holds the CBD reagent solution sample is disposable or reusable; the CBD reagent solution is placed in the CBD Test Module; the CBD Test Module is configured to transmit a submerged band of light from a specific generated wavelength of light source; the remaining non absorbed light is captured by a light sensor achieving the best accuracy without moving parts or refraction and having a minimal fixed gap between the two intrinsically safe electrical parts.

2. The apparatus of claim 1, wherein the CBD reagent solution solution sample is for testing the CBD chemical compound concentration in available CBD Oil products or Hemp Oil products; the available CBD Oil product or Hemp Oil product is diluted in an organic compound and then filtered and placed in an Intrinsically Safe test module to provide repeatable and reliable results.

3. A method of detecting the presence and a relative amount of cannabidiol chemical compound in a CBD Oil or the Hemp Oil product and their respective CBD chemical attributes using specific wavelengths of light in the visible light spectrum for health benefits; the method comprising:
Measuring the amount of remaining non-absorbed light from a CBD reagent solution sample by exposing the CBD reagent solution sample to specific wavelengths of light source submerged in that CBD reagent solution; Measuring the remaining non-absorbed and non-refracted light from a submerged light sensor in that CBD reagent solution suitable for the CBD chemical compound detection; a light sensor generates an output electrical signal relative to the amount of the non-absorbed specific wavelength of light; the output electrical signal provides a quantitative electrical value;
Associating the non-absorbed wavelength of light with the presence and relative amount of the CBD chemical compound concentration in CBD or Hemp extract in the cannabidiol reagent test solution sample for health benefits;
Generating an output electrical signal based on the remaining non absorbed light from the CBD chemical compound based on the ingredients specified in the CBD or Hemp Oil's extract in the CBD reagent test solution sample for health benefits;
Selectively using one or more cannabidiol (CBD) spectrum bands of light using a light source tuned to strong CBD absorption.

4. The apparatus of claim 1, wherein the specific wavelengths of light source and light sensor are submerged in the CBD reagent test solution sample which allows no light refraction and optimal light intensity at different bands of light to be recorded by an output electrical signal which is in relation to the CBD chemical compound concentration absorption and the reagent container holder passage;
said light source and said light sensor operate electrically and safely in the CBD reagent solution; the design of the light source and sensor is suitable for the cannabidiol CBD chemical compound found in retail CBD and Hemp Oil and is capable to record the CBD non-absorbed light.

5. The apparatus of claim 1, wherein the emitted light from the specific wavelengths of light source have the strongest CBD light absorption between 400 to 600 nanometers.

6. The apparatus of claim 1, further comprising of a microcontroller to process the presence and measure relative amount of CBD chemical compound.

7. The apparatus of claim 1, further comprising a wireless communication device to transmit validation results.

8. The apparatus of claim 1, further comprising an electrical meter or signal circuit to validate the presence and measure relative amount of CBD chemical compound.

9. The apparatus of claim 1, using an input DC voltage comprising of a VDC input and intrinsically safe operation as a simple apparatus.

10. The apparatus of claim 1, further comprising of a measurable output current or voltage electrical signal in relation to the CBD chemical compound concentration.

11. The apparatus of claim 2, where in the CBD Test Module and Power Module are integrated together.

12. The method of claim 3, wherein said CBD Test Module and said output electrical signal are calibrated against the organic liquid compound producing the highest output electrical signal for calibration.

13. The method of claim 3, where said the CBD reagent solution samples' is filtered utilizing micro filtering.

14. The apparatus of claim 1, wherein the minimal gap distance between the wavelength of said light source and said light sensor is sized dimensionally and fixed to give the ideal absorption strength and resolution for the CBD reagent test solution sample.

15. The method of claim 3, wherein the Intrinsic safety (IS) protection technique is for safe operation of the electrical light and sensor submerged in the organic compound by limiting the energy, electrical and thermal, available for ignition; the light source and sensor can operate with low currents and voltages.

16. The apparatus of claim 1, wherein said light source and said light sensor are Intrinsically Safe and which are non-energy storing devices.

17. The method of claim 3, wherein there is no light refraction; said submerged light source and said light sensor are in one medium which is the CBD reagent solution.
